(19) United States
(12) Patent Application Publication
(10) Pub. No.: US 2012/0102438 A1
(43) Pub. Date: Apr. 26, 2012

(54) DISPLAY SYSTEM AND METHOD OF DISPLAYING BASED ON DEVICE INTERACTIONS

(76) Inventors: Ian N. Robinson, Pebble Beach, CA (US); April Slayden Mitchell, San Jose, CA (US); Mark C. Solomon, San Jose, CA (US)

(21) Appl. No.: 12/915,311

(22) Filed: Oct. 29, 2010

Related U.S. Application Data
(63) Continuation-in-part of application No. PCT/US2010/053860, filed on Oct. 22, 2010.

(51) Int. Cl. G06F 3/033

(52) U.S. Cl. 715/863

(57) ABSTRACT

The present invention describes a display system capable of interacting with an interfacing device positioned behind a display screen. The display system includes a display, including a display screen that in one embodiment is transparent. The display system further includes: a viewpoint assessment component for determining a viewpoint of a user positioned in front the display screen and an object tracking component for tracking the user manipulation of an object positioned behind the display screen. The display system includes an interaction tracking component. The interaction tracking component receives data regarding predefined interactions with the interfacing device. Responsive to the predefined interactions with the interfacing device, content on the display screen is modified.

### CROSS-REFERENCE TO RELATED APPLICATION

This case is a continuation-in-part of the case entitled “An Augmented Reality Display System and Method of Display” filed on Oct. 22, 2010, having Serial Number PCT/US2010/053860 which is hereby incorporated by reference in it's entirety.

### BACKGROUND

Many mobile devices have a small display screen or no display screen which limits the interface complexity they can present. To overcome the limited display size, some mobile devices link to a desktop or laptop computer device that has a larger display. These mobile devices then use the electronic device having the larger display as the user interface. However, using the desktop or laptop computer as the interface to the electronic device can decrease the intuitive nature of the user interface and ease of use.

### BRIEF DESCRIPTION OF DRAWINGS

The figures depict implementations/embodiments of the invention and not the invention itself. Some embodiments are described, by way of example, with respect to the following Figures.

FIG. 1 illustrates a block diagram of a front view of a display screen in an augmented reality display system with an interfacing device positioned behind the display screen according to an embodiment of the invention;

FIG. 2A shows a front perspective view of a desktop version of an augmented reality display system with the user holding an interfacing device behind the display screen according to an embodiment of the invention;

FIG. 2B shows a side view of a desktop version of an augmented reality display system with the user holding an interfacing device behind the display screen according to an embodiment of the invention;

FIG. 2C shows a perspective back view of a desktop version of an augmented reality display system with the user holding a an interfacing device behind the display screen according to an embodiment of the invention;

FIG. 2D shows a front perspective view of a desktop version of an augmented reality display system with the user holding an interfacing device behind the display screen according to an embodiment of the invention;

FIG. 3A shows a transparent screen display of a display system that illustrates the interaction between a display screen and an interfacing device that is positioned behind the display before transmission of files from the device to the display screen according to one embodiment of the invention;

FIG. 3B shows a transparent screen display of a display system that illustrates the interaction between a display screen and an interfacing device that is positioned behind the display during transmission of files from the device to the display screen according to one embodiment of the invention;

FIG. 3C shows a transparent screen display of a display system that illustrates the interaction between a display screen and an interfacing device that is positioned behind the display after the transmission of files from the device to the display screen is complete according to one embodiment of the invention;

FIG. 4 shows a transparent screen display of a display system that illustrates the interaction between a display screen and a keyboard that is positioned behind the display according to one embodiment of the invention;

FIG. 5A shows the interaction between a user and a ring structure device that is positioned behind the display screen according to one embodiment of the invention;

FIG. 5B shows a menu that results from the interaction with the user with the ring structure device shown in FIG. 5A according to one embodiment of the invention;

FIG. 6 shows a flow diagram for a method of displaying content for augmenting the display of an interfacing device positioned behind a transparent display screen according to an embodiment of the invention;

FIG. 7 shows a computer system for implementing the methods shown in FIG. 6 and described in accordance with embodiments of the present invention.

The drawings referred to in this Brief Description should not be understood as being drawn to scale unless specifically noted.

### DETAILED DESCRIPTION OF EMBODIMENTS

For simplicity and illustrative purposes, the principles of the embodiments are described by referring mainly to examples thereof. In the following description, numerous specific details are set forth in order to provide a thorough understanding of the embodiments. It will be apparent, however, to one of ordinary skill in the art, that the embodiments may be practiced without limitation to these specific details. Also, different embodiments may be used together. In some instances, well known methods and structures have not been described in detail so as not to unnecessarily obscure the description of the embodiments.

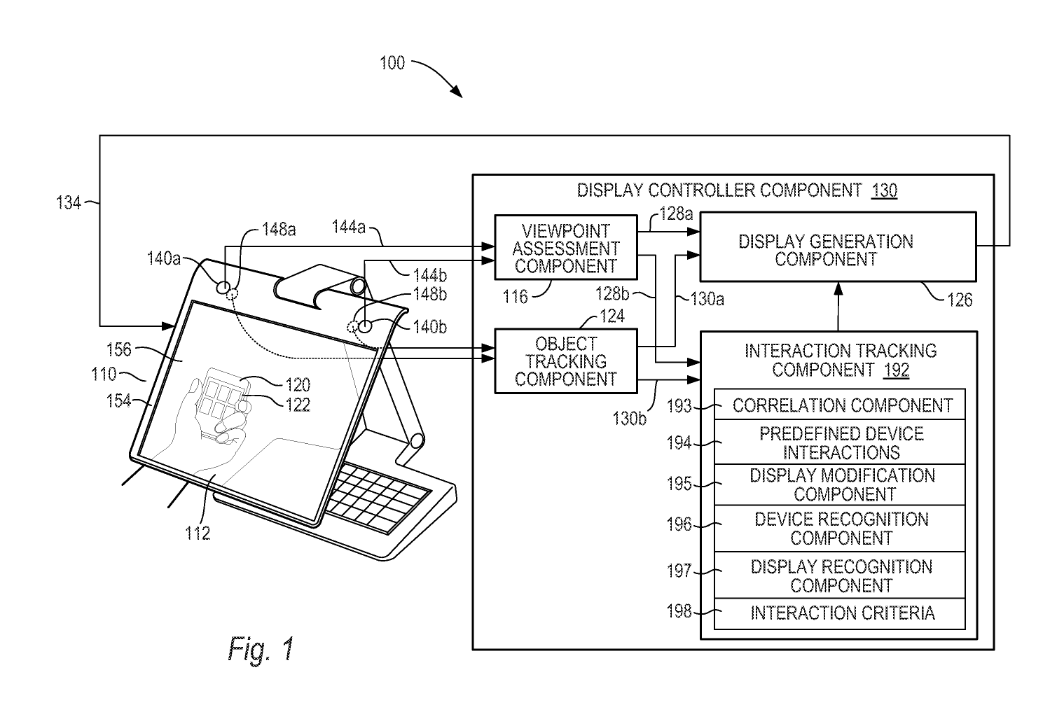

The present invention describes a method and system capable of interacting with an interfacing device positioned behind a display screen. FIG. 1 illustrates a block diagram of a front view of a display screen in an augmented reality display system where an interfacing device is positioned behind the display screen. The display system 100 is comprised of: a display 110, including a display screen 112; a viewpoint assessment component 116 capable of determining a viewpoint of a user positioned in front the display screen 112; and an object tracking component 124 capable of tracking the user manipulation of an object 120 positioned behind the display screen 112. The display system further includes an interaction tracking component 192 capable of receiving data regarding predefined interactions with an interfacing device 120. Responsive to the occurrence of the predefined interactions by the electronic device—content on the display screen 112 is modified.

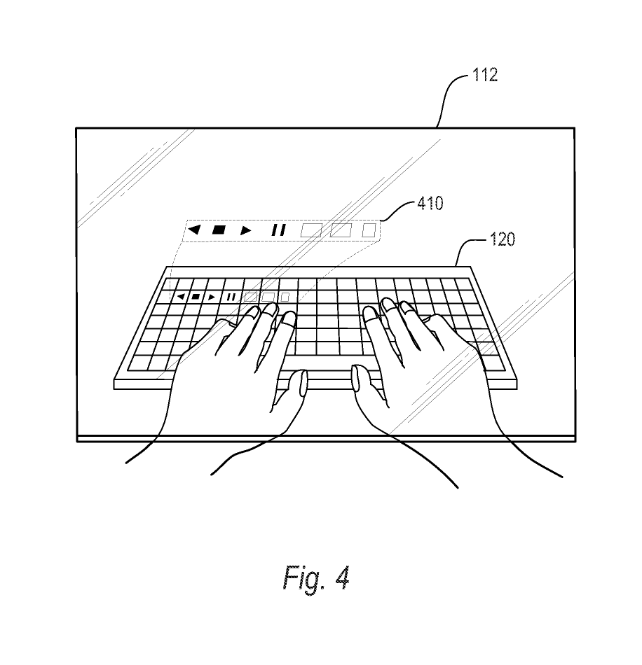

In the embodiments described, the display 112 of the display system 110 provides a larger display screen than the display of the interfacing device 120. In fact in some cases (say for the keyboard example described with respect to FIG. 4), the interfacing device 120 has no display screen. A larger display screen is often desirable to the user, as it provides an expanded interaction capability not available on the display of a small handheld interfacing device. The expanded display provides display space so that the user, previously limited by the small (or no) display screen, can now more easily perform complex interactions that were not possible or extremely difficult on the small communicative device.

One benefit of the present invention is that actions selected and the resulting content presented on the expanded display output is controlled by the interactions with the interfacing device itself. This is in contrast to some systems where the user controls the output to the expanded screen of the computing device using the interfaces to the computing device itself and not by directly manipulating or interacting with the interfacing device 120 itself.

In contrast, the present invention allows the user to hold and manipulate the interfacing 120 device. This provides a very natural, intuitive way of interacting with the device while still providing an expanded display for the user to interact with. For example, say an interfacing device such as a handheld mobile device is positioned behind an expanded transparent display screen 112 which shows several photographs on the display screen positioned to the right and in front of the interfacing device 120. If the interfacing device includes an arrow key, the user could simply hold the interfacing device and use the arrow on the device to point to a specific photograph on the expanded screen 112 to interact with. This would be in contrast to, for example, the user interacting with a mouse of the PC to move to the arrow key on the visual representation of the interfacing device and clicking on the arrow to move to the picture they wish to select.

In one embodiment, the content displayed on the display screen 112 is an overlaid image. The display system 100 creates an “overlaid” image on the display screen 112—where the overlaid image is an image generated on the display screen that is between the user's viewpoint and the object 120 behind the screen that it is “overlaid” on. Details regarding how the overlaid image is generated is described in greater detail in the patent application having the title “An Augmented Reality Display System and Method of Display” filed on Oct. 22, 2010, having Serial Number PCT/US2010/053860. The overlaid image generated is dependent upon the user's viewpoint. Thus, the position of the overlaid image with respect to the object behind the display screen stays consistent even as the user moves their head and/or the object behind the display screen.

In one embodiment, the overlaid image is created by the display controller component 130 responsive to the viewpoint of the user and the position of the display screen. FIG. 1 shows viewpoint assessment sensors 140a, 140b positioned to face towards the user to capture the user's head position or facial detail. The viewpoint assessment sensor data 144a, 144b is used by the viewpoint assessment component 116 to determine the user's viewpoint.

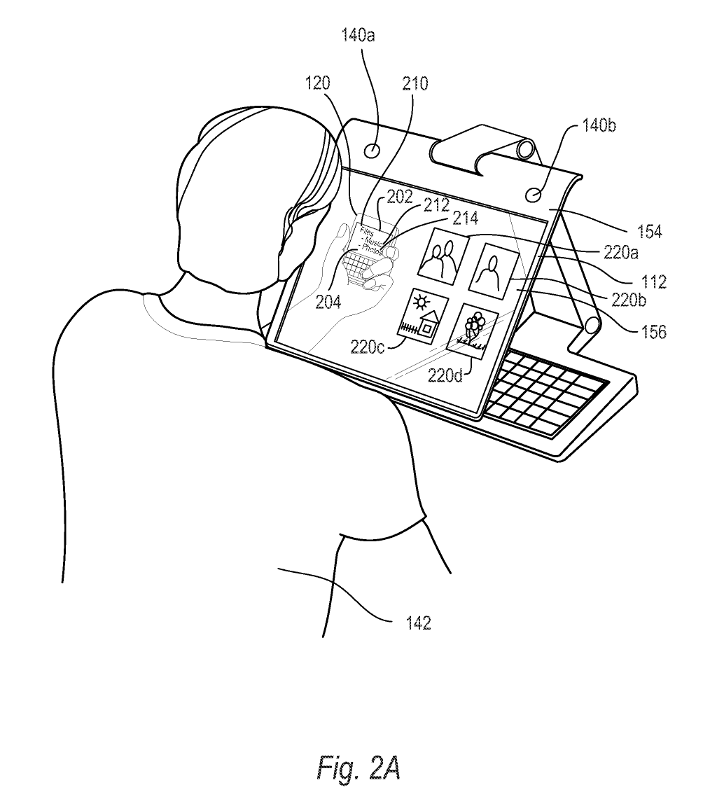

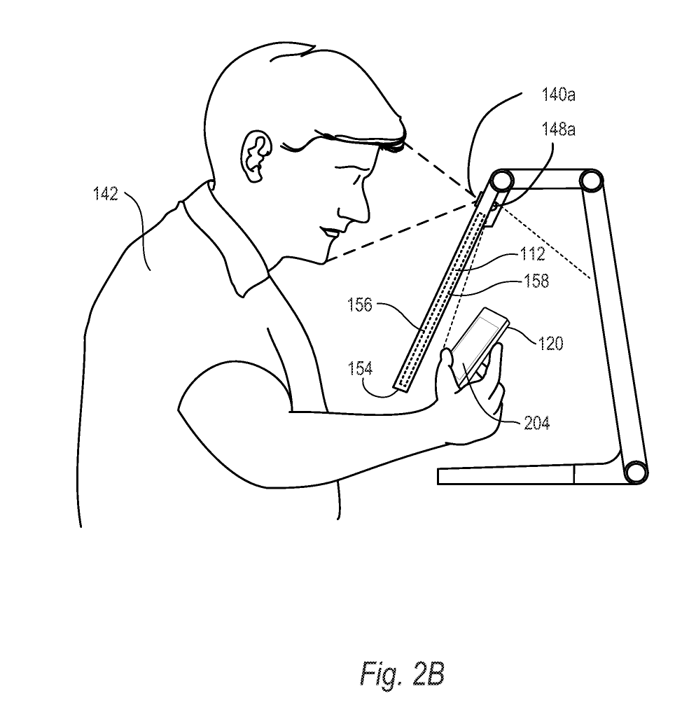

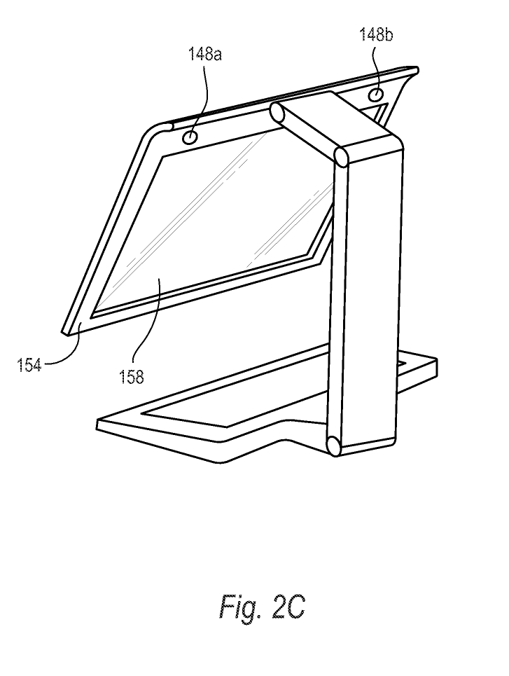

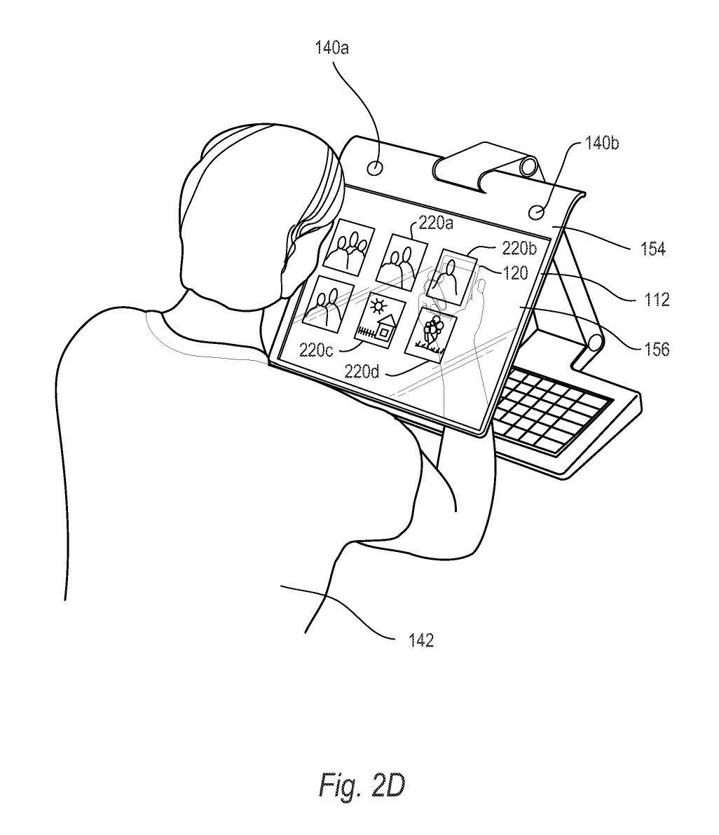

In addition, the display system 100 shown in FIG. 1 includes one or more object tracking sensors 148a, 148b covering the space behind the display screen to sense objects (including the user's hands) positioned behind the display screen. FIG. 2C shows a perspective back view of a desktop version of an augmented reality display system according to an embodiment of the invention where the object tracking sensors 148a, 148b can be more clearly seen.

In addition, the display system also can include a display generation component 126, wherein based on data 128 from the viewpoint assessment component 116 and data 130a from the object tracking component 124, the display generation component 126 creates content for the display on the display screen 112. The display controller component 130 outputs data 134 from at least the display generation component 126 to the display screen 112. Data (128a, 130a) output from the viewpoint assessment component 116 and the object tracking component 124 is used by the display generation component to generate an image on the display screen that overlays or augments objects placed behind the screen.

The display system includes an interaction tracking component 192. In the embodiment shown in FIG. 1, the interaction tracking component 192 is part of the display controller component 130. The interaction tracking component 192 is capable of receiving data from the interfacing device 120 regarding interactions of the interfacing device. Responsive to predefined interactions 194 with the interfacing device 120, content on the display screen is modified according to the display modification component 195.

In one embodiment, the interaction tracking component 192 includes a predefined list of device interactions 194 and the resulting outputs on the display (display modification 195). For example, pressing the delete key on the interfacing device might be one possible interaction. The result (the display modification) in this instance might be that the highlighted item is deleted or removed from the display screen. Information about the possible interactions 194 by the interfacing device 120 and the display modification 195 by the display 110 that results from the interaction 194 are stored and used by the interaction tracking component 192 and display generation component 126 to generate a display.

In the embodiment shown in FIG. 1, sensors (e.g., the viewpoint assessment sensor 140a-b and object tracking sensors 148a-b) collect data that is communicated to the interaction tracking component 192 of the display system 100. Based on sensor data, the interaction tracking component 192 can determine if the interaction by the interfacing device 120 meets the interaction criteria. If the interaction criteria is met, then the content on the display can be modified.

The type of display modification can be dependent upon the interaction by the interfacing device and in some cases is additionally dependent upon the type of interfacing device and the type of display used in the display system. Information stored about the type of display is stored in the display recognition component 197. Information stored about the type of device is stored in the device recognition component 196. In one embodiment, this information can be used by the display generation component 126 to determine the type of output displayed. For example, the display generation component might choose to output larger print on a menu on a display type that had very low resolution as compared to a display type that had very high resolution.

As previously stated, the interaction tracking component 192 includes a predefined list of device interactions 194 that result in the display screen being modified. Although not limited to these examples, some examples of user interactions with the interfacing device that could result in a display modification include: pushing a button on the interfacing device, scrolling a jog wheel on interfacing device, moving the cursor of the interfacing device, the act of putting the interfacing device behind the transparent display screen, performing a recognizable gesture in the vicinity of the interfacing device, physically manipulating the interfacing device (i.e. shaking the interfacing device, turning the interfacing device upside down, etc.).

In one embodiment, the user interaction with an interfacing device 120 is sensed by sensors in the vicinity of the display system (such as the view assessment sensor 140a-b or object tracking sensors 148a-b). In an alternative embodiment, whether user interaction has occurred can be communicated electronically from the interfacing device to the display system. For example, consider the case where the user pushes a button on the interfacing device 120. In one embodiment, the object tracking sensors behind the display screen could sense when the user's fingers come into contact with a button on the display of the interactive device. The sensor data could be sent to the interaction tracking component 192. In another embodiment, the interfacing device 120 is in wireless communication with the interaction tracking component 192 and when a predefined button on the interfacing device is pressed, a signal is transmitted to the interaction tracking component. Based on the signal information transmitted, the display system 100 can determine that an interaction has occurred.

In one embodiment, for a particular device, a predefined interaction 192 with the interfacing device 120 results in a predefined display modification when the interaction criteria 198 are met. Referring to FIG. 1, the interaction tracking component 192 includes a correlation component 193 which correlates which interaction by the interfacing device corresponds to which display modification or output. The display output may be based on the type of device. Thus, the correlation component 193 may include a device recognition component 196 and a display recognition component 197. For example, based on an interfacing device being placed under the display screen (the interaction), an output on the display screen is modified (a menu pops up.) The type of device that is recognized may determine the type of menu that pops up since the type of menu is in part based on the available functionality of the interfacing device. Similarly, the display generated may change based on the type of display available (area of display, dimensions, resolution, etc.) in order to optimize the menu and menu layout based on the characteristics of the display.

In one case ultrasound, visual or infrared technologies may be used for tracking position. For determining the orientation of the device, the device could include an inbuilt accelerometer. Alternatively, the interfacing device 120 could include a magnet that could be detected by magnetometers incorporated into the display (or vice versa). Alternatively, the device could have visibly recognizable markings on its exterior or augmented reality (AR) codes that enable recover of orientation from cameras located on the display. The interfacing device could also include a camera. Devices 120 that incorporate a camera could recover their position and orientation by recognizing IR beacons on the display screen or even fiducial patterns presented on the display.

As previously stated, a predefined interaction with the interfacing device results in a predefined display modification 195 when the interaction criteria 198 are met. Although, not limited to these examples, some examples of modifications to the display based on interactions by the communicative device meeting interaction criteria would be: the output of menu on the display screen, the output of an overlaid image that augments or changes the functionality of the device behind the display screen, the appearance or removal of files from the display screen, etc.

FIG. 2A shows a front perspective view of an augmented reality display system (such as is shown in FIG. 1) with the user holding an interfacing device behind the display screen according to an embodiment of the invention. The display 110 includes a display screen 112 that is comprised of a transparent screen material. Although alternative materials and implementations are possible, the transparent display screen operates so that interfacing device 120 positioned behind the display screen 112 can be easily seen or viewed by a user 142 positioned in front of the display screen 112. The transparent display screen allows the user 142 to have a clear view of the device 120 (or devices) behind the screen that are being manipulated in real time and to instantaneously see the effect of their manipulation on the display 112. The user can interact with the interfacing device 120 and the display 112 to perform operations in an intuitive manner.

Referring to FIG. 2A shows a user 142 interacting with an interfacing device 120 behind the transparent display screen 112. The device 120 is capable of communicating with the display system 100. Based on interactions performed by the user directly or indirectly with the interfacing device and whether interaction criteria are met, the display screen output is modified. Thus, in effect the interactions of the interfacing device 120 controls what is output on the display screen. How the display screen 112 is modified is based on the type of user interaction with the device 112.

Because the output or content displayed on the display screen 112 is dependent upon the controlling interactions, the interfacing device in effect has an expanded display that is capable of providing the user expanded content to interact with. The expanded content is generated and controlled at least in part by whether interaction with the interfacing device meets the predefined interaction criteria 198. If the interaction or manipulation of the device 120 meets the predefined interaction criteria, the content being displayed on the display screen 112 (the expanded screen) is modified.

An example of one possible user interaction is described with respect to FIG. 2A. In the embodiment shown in FIG. 2A, files 220a-d have been transferred from the interfacing device 120 positioned behind the screen to the expanded display screen of the display system 100 using a menu 202 on the device 120. In the embodiment shown, the interfacing device 120 includes a display screen 204 that includes a menu 202 that can be manipulated by a user to select an operation or desired action. In the embodiment shown, the menu has a Files tab 210. Underneath the Files tab 210 is a Music tab 212 and a Photo tab 214. Assuming that user selection of a File tab 210 is a predefined interaction recognizable by the interaction tracking component 192, in response to the user selecting the Photo Tab 214 on the menu 202—photos 220a-d stored on the interfacing device are displayed on the display screen 112.

In one embodiment, the image or content on the display screen 112 has a spatial relationship to the interfacing device 120 on the display screen 112. For example, in the embodiment shown in FIG. 2A, the photographic files 220a-d are shown on the display screen 112 to the right of the interfacing device 120—so that the interfacing device 120 can be clearly seen behind the transparent screen if the user decides to interact with the interfacing device or the displayed content. In an alternative embodiment, the image or content displayed on the display screen has no spatial relationship to the interfacing device. For example, the photographic files 220a-d might be spaced across the entire screen in multiple rows, equidistant apart so that they appear in front of the interfacing device. Alternatively, the photographic files 220a-d might be spaced randomly across the display screen.

In one embodiment, the content on the display screen 112 stays static and the interfacing device is moved behind the screen to select content. FIG. 2D shows a front perspective view of a desktop version of an augmented reality display system with the user holding a interfacing device 120 behind the display screen 112 according to an embodiment of the invention. In FIG. 2D, for example, an interfacing device 120 is moved behind displayed contents on the transparent screen (similar to a mouse) to perform selections of the displayed content. In the example shown in FIG. 2D, the user moves the interfacing device 120 behind photo 220b to indicate that he wishes to select this particular photo. To better illustrate the user's hand and device position, FIG. 2D shows the user's hand and device behind the photos 220a-d so that the photographs appear transparent. In an actual physical setting, parts of the user's hand and parts of the device 120 shown in FIG. 2D could be occluded.

In one embodiment, to select a particular photo, the interfacing device 120 should meet the interaction criteria 198 (e.g., sensed within a predefined distance of the photo and with 50% overlap of the display screens), to be selected. In one example, buttons on the device could be used to indicate the selection. In another example, the back surface 158 of the transparent screen is a touch sensitive surface and selection of a particular item or photo can be chosen simply touching the back of the display screen.

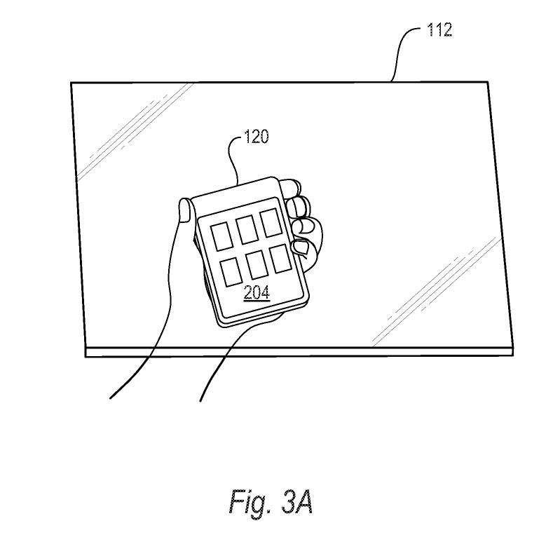

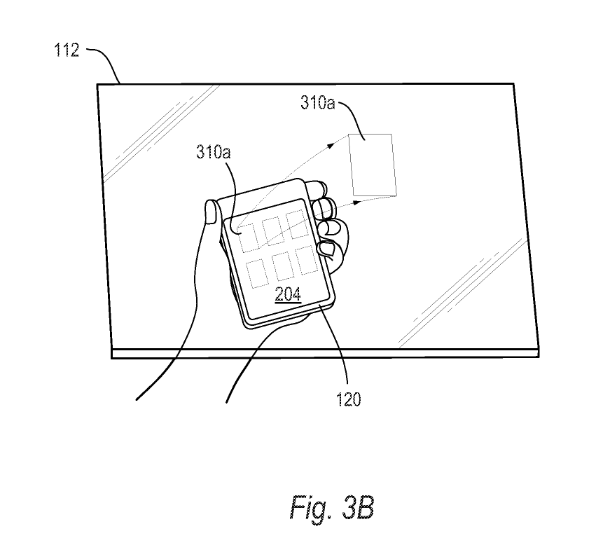

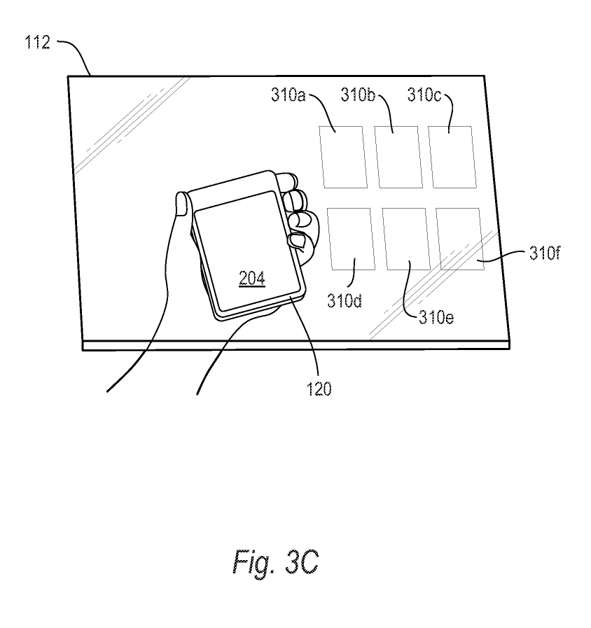

In one embodiment, the predefined interactions 194 by the interfacing device are coordinated so that the content displayed on the display 204 of the interfacing device 120 is coordinated with the content displayed on the display 112 of the display system 100. This coordination can be more easily seen and described, for example, with respect to FIGS. 3A-3C.

FIG. 3A shows a display system 100 that illustrates the interaction between a display screen 112 (controlled by the display system) and the display screen 204 of an interfacing device 120 positioned behind the display screen before the transmission of files from the device to the display. FIG. 3B shows a display system 100 that illustrates the interaction between a display screen 112 (controlled by the display system) and the display screen 204 of an interfacing device 120 during the transmission of files from the device to the display. FIG. 3B shows a display system 100 that illustrates the interaction between a display screen 112 (controlled by the display system) and the display screen 204 of an interfacing device 120 after the transmission of files from the device to the display screen is complete. All of the usual device to display interactions can be supported, but by coordinating the output on the displays of the two devices (the interfacing device 120 and the display 110 of the display system 100) the interactions can be more strongly visualized.

Referring to FIGS. 3A-3C shows the movement of files from the interfacing device to the larger display screen 112. Referring to FIG. 3A shows a display system with an interfacing device behind the display screen, before the transmission of files. In one example, the user initiates the transfer of files by choosing the transfer function from a menu on the interfacing device so that files from the interfacing device begin being transferred to the display screen.

Referring to FIG. 3B, shows a file 310a in the process of being transferred from the interfacing device 120a to the display screen 112. In the example shown, a file 310 disappearing from the interfacing device 120 would appear on the display 110. Because of the coordination between the display screens, the user is able to clearly visualize the transition of the files between the display screen of the interfacing device 120 to the display screen 112 of the display system 100. FIG. 3C shows the files after the file transfer is complete. In the embodiment shown, six files 310a-310f were transferred between the devices.

FIG. 4 shows a transparent screen display 112 of a display system 100 that illustrates the interaction between a display system and a keyboard 120 that is positioned behind the display according to one embodiment of the invention. As the keyboard (the interfacing device) has no display screen, the display system enables a visual interface or display for the keyboard. The display system outputs an overlay image 410 that is used to reassign the key functions of the standard keyboard shown. The image 410 is aligned to the keyboard so that the user when viewing the keys sees the alternative functions assigned to the keys. This reassignment is useful when the user wants to use a standard keyboard for application specific functions, such as gaming, video editing, etc.

In the embodiment—interaction with the interfacing device includes placing the keyboard (the interfacing device) behind the display screen interfacing. When the keyboard is sensed (interaction criteria met), the display output is modified by adding an image of a reassignment label 410 that supports alternative key functions.

One possible example of an interfacing device with no display would be an electronic music player that stores and plays music. The music player could randomly reassign the order of the stored songs for playback. However, the user might find it desirable to provide a designated order that the songs would be played in. In this case, placing the electronic music storage device behind the transparent screen (interaction) would result in a menu (display modified) popping up. In one example, the at least a subset of the possible songs of choice would be displayed by album cover on the transparent display screen. The user could select the order of the song by interacting with the menu or alternatively by selecting songs using the electronic song storage device as a selection means.

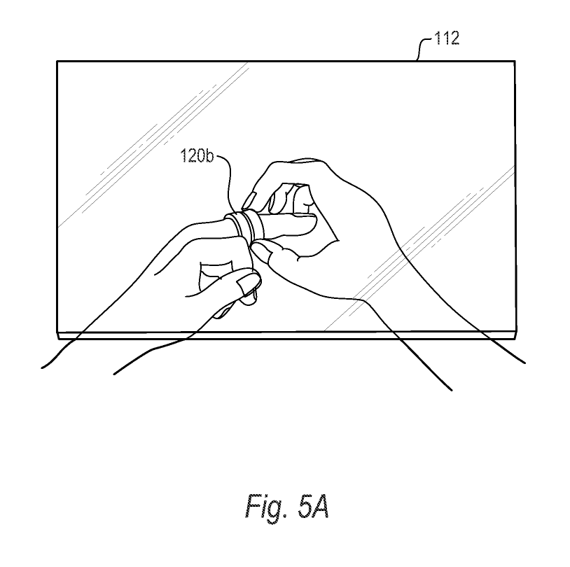

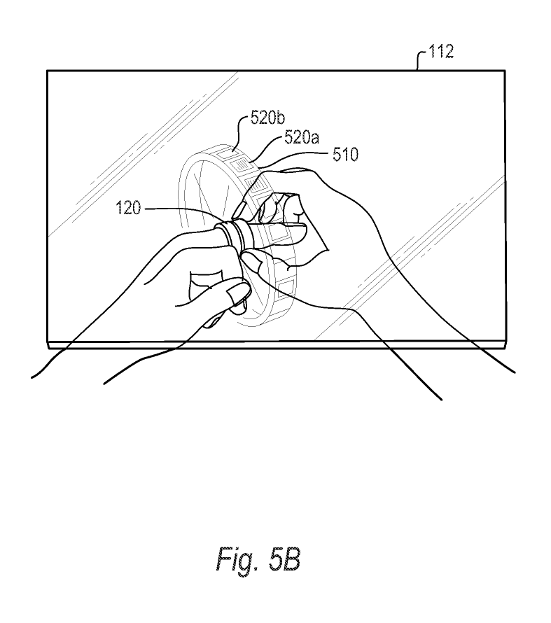

FIGS. 5A and 5B show a transparent screen display of a display system that illustrates the interaction between a display screen 112 and a ring structure 120 that is positioned behind the display according to one embodiment of the invention. This is similar to the embodiment shown in FIG. 4, in that both interfacing devices (the keyboard and ring structure device) do not have their own display.

FIG. 5A shows the interaction between a user and a ring structure device that is positioned behind the display screen according to one embodiment of the invention. Referring to FIG. 5A, the user is beginning to twist (the interaction) the ring structure device on his finger. Based on this interaction, the circular menu 510 shown in FIG. 5B is output to the display screen 112.

Although in one embodiment, a menu could appear on the display screen that was planar with the display screen surface, in the embodiment shown in FIG. 5B, the overlay image created (the circular menu) rendered so that it appears to be co-located with the device behind the display screen. In one embodiment, the circular menu appears to be floating around the ring structure device 120. User interaction with the ring structure 120 shown, is by interacting with the menu in the 3D space or volume behind the screen. Because the interaction is with a virtual object, in one example feedback is given to let the user know the interaction was successful.

In one embodiment, the user twists the ring structure 120 to control the position of the circular menu 510. When the user comes to a defined position on the circular menu, the user can select that item (for example 520a). In one example, selection by the user of a particular item 520a-n results in the opening of a submenu. Based on the position of the ring—the circular menu 510 offers different alternative selections to the user.

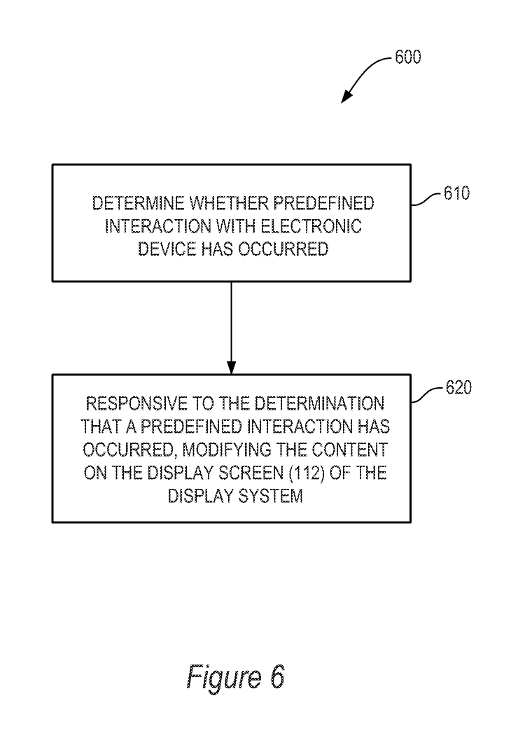

FIG. 6 shows a flow diagram for a method of displaying content for augmenting the display of an interfacing device positioned behind a transparent display screen according to an embodiment of the invention. Specifically, FIG. 6 shows the method 600 of generating content responsive to whether a predefined interaction has occurred. The steps include: determining whether a predefined interaction with a interfacing device has occurred (step 610), wherein responsive to the determination that a predefined interaction has occurred, content on the display screen is modified (step 620). Specifically for the display system of the present invention, which includes viewpoint assessment sensors and object tracking sensors—wherein the location of the modified content on the display screen is based on the user viewpoint and the location of the interfacing device. The location of the content that is displayed is determined using the methods described in more detail in the case entitled “An Augmented Reality Display System and Method of Display” filed on Oct. 22, 2010, having Serial Number PCT/US2010/053860.

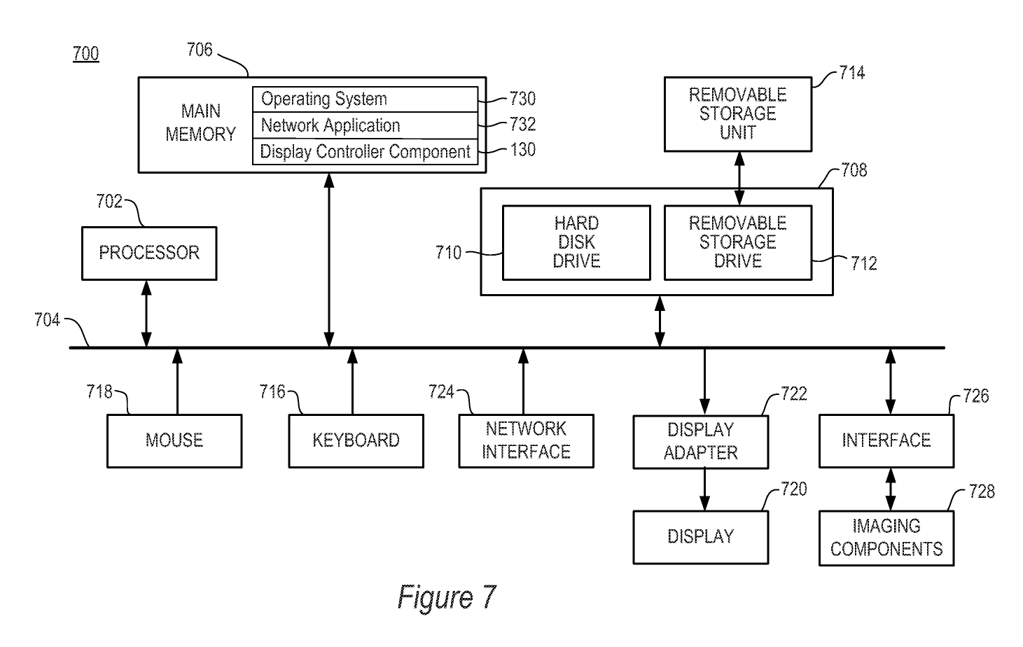

FIG. 7 shows a computer system for implementing the methods shown in FIG. 6 and described in accordance with embodiments of the present invention. It should be apparent to those of ordinary skill in the art that the method 600 represents generalized illustrations and that other steps may be added or existing steps may be removed, modified or rearranged without departing from the scopes of the method 600. The descriptions of the method 600 are made with reference to the system 100 illustrated in FIG. 1 and the system 700 illustrated in FIG. 7 and thus refers to the elements cited therein. It should, however, be understood that the method 600 is not limited to the elements set forth in the system 700. Instead, it should be understood that the method 600 may be practiced by a system having a different configuration than that set forth in the system 700.

Some or all of the operations set forth in the method 600 may be contained as utilities, programs or subprograms, in any desired computer accessible medium. In addition, the method 600 may be embodied by computer programs, which may exist in a variety of forms both active and inactive. For example, they may exist as software program(s) comprised of program instructions in source code, object code, executable code or other formats. Any of the above may be embodied on a computer readable medium, which include storage devices and signals, in compressed or uncompressed form.

FIG. 7 illustrates a block diagram of a computing apparatus 700 configured to implement or execute the methods 600 depicted in FIG. 6, according to an example. In this respect, the computing apparatus 700 may be used as a platform for executing one or more of the functions described hereinabove with respect to the display controller component 130.

The computing apparatus 700 includes one or more processor(s) 702 that may implement or execute some or all of the steps described in the method 600. Commands and data from the processor 702 are communicated over a communication bus 704. The computing apparatus 700 also includes a main memory 706, such as a random access memory (RAM), where the program code for the processor 702, may be executed during runtime, and a secondary memory 708. The secondary memory 708 includes, for example, one or more hard drives 710 and/or a removable storage drive 712, representing a removable flash memory card, etc., where a copy of the program code for the method 700 may be stored. The removable storage drive 712 reads from and/or writes to a removable storage unit 714 in a well-known manner.

Exemplary computer readable storage devices that may be used to implement the present invention include but are not limited to conventional computer system RAM, ROM, EPROM, EEPROM and magnetic or optical disks or tapes. Concrete examples of the foregoing include distribution of the programs on a CD ROM or via Internet download. In a sense, the Internet itself is a computer readable medium. The same is true of computer networks in general. It is therefore to be understood that any interfacing device and/or system capable of executing the functions of the above-described embodiments are encompassed by the present invention.

Although shown stored on main memory 706, any of the memory components described 706, 708, 714 may also store an operating system 730, such as Mac OS, MS Windows, Unix, or Linux; network applications 732; and a display controller component 130. The operating system 730 may be multi-participant, multiprocessing, multitasking, multithreading, real-time and the like. The operating system 730 may also perform basic tasks such as recognizing input from input devices, such as a keyboard or a keypad; sending output to the display 720; controlling peripheral devices, such as disk drives, printers, image, capture device; and managing traffic on the one or more buses 704. The network applications 732 includes various components for establishing and maintaining network connections, such as software for implementing communication protocols including TCP/IP, HTTP, Ethernet, USB, and FireWire.

The computing apparatus 700 may also include an input devices 716, such as a keyboard, a keypad, functional keys, etc., a pointing device, such as a tracking ball, cursors, etc., and a display(s) 720, such as the screen display 110 shown for example in FIGS. 1-5. A display adaptor 722 may interface with the communication bus 704 and the display 720 and may receive display data from the processor 702 and convert the display data into display commands for the display 720.

The processor(s) 702 may communicate over a network, for instance, a cellular network, the Internet, LAN, etc., through one or more network interfaces 724 such as a Local Area Network LAN, a wireless 702.11x LAN, a 3G mobile WAN or a WiMax WAN. In addition, an interface 726 may be used to receive an image or sequence of images from imaging components 728, such as the image capture device.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purposes of illustration and description. They are not intended to be exhaustive of or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

What is claimed is:

1. A display system comprising:
A display including a display screen configured to operate in at least a transparent mode, the transparent mode allowing viewing of a an interfacing device positioned behind the display screen;
A viewpoint assessment component for determining the viewpoint of a user positioned in front of the display screen;
An object tracking component for tracking user manipulation of the interfacing device behind the display screen; and
An interaction tracking component for receiving data regarding predefined interactions with the interfacing device, wherein responsive to predefined interactions content on the display screen is modified.

2. The display system recited in claim 1, wherein the interfacing device further includes a display screen.

3. The display system recited in claim 2, wherein the content on the display screen of the interfacing device and the content on the display of the display system are coordinated.

4. The display system recited in claim 1, wherein the display screen of the display system provides an expanded display for the interfacing device.

5. The display system recited in claim 1 wherein content on the display screen of the display system is positioned so that it overlays the interfacing device behind the display screen of the display system.

6. The display system recited in claim 5 wherein the overlay position is based on the user viewpoint and the location of the interfacing device.

6. A method of displaying content, comprising the steps of:
Determining whether a predefined interaction with an interfacing device has occurred, wherein the interfacing device is positioned behind a transparent display screen in a display system, the display system including a viewpoint assessment component for determining a user viewpoint and object tracking component for determining the location of the interfacing device,
Wherein responsive to the determination that a predefined interaction has occurred, content on the display screen is modified

7. The method recited in claim 6, wherein the location of the modified content on the display screen is based on the user viewpoint and the location of the interfacing device.

8. The method recited in claim 6 further including the step of defining the predefined interactions.

9. The method recited in claim 7 further including the step of communicating the predefined interactions to both the interfacing device and the display system.

10. The method recited in claim 6 wherein the interfacing device includes a display screen, wherein the method further includes the step of coordinating the content on the display screen of the display system with the content on the display screen of the interfacing device.

11. A computer readable storage medium having computer readable program instructions stored thereon for causing a computer system to perform instructions, the instructions comprising the steps of:
Determining whether a predefined interaction with an interfacing device has occurred, wherein the interfacing device is positioned behind a transparent display screen in a display system, the display system including a viewpoint assessment component for determining a user viewpoint and object tracking component for determining the location of the interfacing device,
Wherein responsive to the determination that a predefined interaction has occurred, content on the display screen is modified

12. The method recited in claim 11, wherein the location of the modified content on the display screen is based on the user viewpoint and the location of the interfacing device.

13. The method recited in claim 11 further including the step of defining the predefined interactions.

14. The method recited in claim 12 further including the step of communicating the predefined interactions to both the interfacing device and the display system.

15. The method recited in claim 11 wherein the interfacing device includes a display screen, wherein the method further includes the step of coordinating the content on the display screen of the display system with the content on the display screen of the interfacing device.
